(19) United States
(12) Patent Application Publication
(10) Pub. No.: US 2022/0371357 A1
(43) Pub. Date: Nov. 24, 2022

(54) INFLATABLE WHITEBOARD

(71) Applicant: Ryan Andrews, Temecula, CA (US)

(72) Inventor: Ryan Andrews, Temecula, CA (US)

(21) Appl. No.: 17/752,809

(22) Filed: May 24, 2022

Related U.S. Application Data
(60) Provisional application No. 63/192,437, filed on May 24, 2021.

(51) Int. Cl. B43L 1/00; B43L 19/00

(52) U.S. Cl. CPC B43L 1/00; B43L 19/00

(57) ABSTRACT

An inflatable white board includes at least one sheet and at least one inflatable portion constructed and arranged to provide rigidity to the inflatable white board. The inflatable whiteboard may include a sheet constructed and arranged to function as marker board, dry erase board, dry-wipe board, pen board, or the like. The sheet may have one or more layers, such as a writable/erasable top layer and a bottom layer. The inflatable whiteboard may be reusable and may be deflated for ease of storage and transport. The inflatable whiteboard may include a writing instrument holder

### CROSS-REFERENCE TO OTHER APPLICATIONS

This application is a Non-Provisional application that claims the benefit of prior co-pending Provisional Patent Application No. 63/192,437, filed on May 24, 2021, incorporated herein by reference in its entirety.

### TECHNICAL FIELD

The embodiments generally relate to the field of signage, and more specifically to inflatable signs.

### BACKGROUND

Signage, and in particular portable signage, may be cumbersome and difficult to store, transport, and reuse. Generally, signs are made of solid, inflexible materials such that a manufactured sign cannot be reduced in size or volume without breaking or taking apart parts of the sign. Furthermore, even if broken down in parts, inflexible signs will still have parts, such as the writing surface and the frame edges, that will not be amenable to breaking apart in further subparts and will require protective packaging that might occupy significant additional transportation space, weight, and/or protective elements (such as packaging foam) depending at least on the size, parts, shape, structural stability, and mode of transportation for the signs. Thus, there is a need in the art for, and/or it would be a benefit for the art to have, a sign that is flexible and can become sturdy and rigid for its use, providing both the benefits of transportation, shipping, and handling of a flexible and lightweight item while also providing the functionality of traditional signs.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

An inflatable whiteboard may include a sheet and an inflatable portion constructed and arranged to provide rigidity to the sheet when the inflatable portion is inflated.

According to one aspect of the inflatable whiteboard, the sheet may be a rigid or flexible layer of material which may be used as a whiteboard, such as, for use with dry erase markers or similar erasable writing tools. The sheet may have one or more layers. The one or more layers may include a top layer and/or a bottom layer. The top layer, the bottom layer, or both may be writable and erasable, that is, can be written on with a writing instrument (such as a dry erase markers) and erased.

According to one aspect of the inflatable whiteboard, the inflatable portion may be a single inflatable portion or a plurality of inflatable portions disposed around the sheet or a portion of the sheet such that, when inflated, the inflatable portion provides rigidity to the sheet.

According to one aspect of the inflatable whiteboard, the sheet and/or the inflatable portion have one or more logo areas (at least one logo area).

According to one aspect of the inflatable whiteboard, the sheet, and/or the inflatable portion have one or more writing instrument holders. The one or more writing instrument holders may be attached, connected, and/or tied to the inflatable whiteboard, the sheet, and/or the inflatable portion. The writing instrument holder (or the one or more writing instrument holders) may comprise one or more loops, each loop defining an opening

According to one aspect of the inflatable whiteboard, the writing instrument holder is attached, connected, or tied to an area of the inflatable portion facing the same direction as the top layer, bottom layer, front, back, up, down, left, right, or any angle between the foregoing directions.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of an inflatable whiteboard according to some variations described herein.

FIG. 2 illustrates a bottom-side view of an inflatable whiteboard according to some variations described herein.

FIG. 3 illustrates a topside view of an inflatable whiteboard according to some variations described herein.

FIG. 4 illustrates a left-side view of an inflatable whiteboard according to some variations described herein.

FIG. 5 illustrates a right-side view of an inflatable whiteboard according to some variations described herein.

FIG. 6 illustrates a front view of an inflatable whiteboard according to some variations described herein.

FIG. 7 illustrates a back view of an inflatable whiteboard according to some variations described herein.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

An inflatable whiteboard may include at least one sheet and at least one inflatable portion. The inflatable white board may further include at least one valve constructed and arranged to allow a user to inflate the inflatable portion. The inflatable white board may include a sheet constructed and arranged to function as marker board, dry erase board, dry-wipe board, or pen board. The inflatable white board may be reusable and may be deflated for ease of storage and transport.

The sheet may be a layer of rigid or flexible material suitable for use with temporary markers, pens, pencils, or the like which may be easily erased from the sheet. As non-limiting examples, the sheet may be made of a rigid material such as plastic, paperboard, wood, metal, or other material. According to one or more aspects, the sheet may be a layer of rigid or flexible material suitable for use with permanent and/or temporary markers, pens, pencils, or the like which may (or may not) be easily erased from the sheet. A surface layer may be disposed on the sheet and which may be constructed and arranged for use with temporary markers, pens, pencils, or the like which may be easily erased from the surface layer. The surface layer may include materials suitable for the purposes of acting as a dry erase board including, but not limited to, melamine, hard coat laminates, painted metals, enamels, polypropylene films, tempered glass, or the like. For example, the sheet may be made of paperboard and may have a vinyl top layer disposed thereon and which may be used with erasable writing utensils. Alternatively, the sheet may be a flexible material such as vinyl, plastic, or cloth suitable for use with erasable writing utensils. A surface layer may be disposed on the sheet and which may be constructed and arranged for use with temporary markers, pens, pencils, or the like which may be easily erased from the surface layer. For example, the sheet may be flexible cloth having a top layer or coating disposed thereon in which may be used with erasable writing utensils. The sheet may be made from any suitable material for the purposes of and erasable markerboard and may include high gloss vinyl, coated paper, high gloss paints, acrylic coatings, or the like.

The inflatable portion may be removably connected to the sheet and may be constructed and arranged to provide rigidity to the sheet. The inflatable portion may define a hollow section therein which may be inflated. The inflatable portion may include a valve constructed and arranged to allow a user to inflate the inflatable portion with air or any other suitable fluid. The inflatable portion may include a plurality of inflatable portions each having their own respective valve or blowhole. The inflatable portion may be constructed and arranged to form a frame around the sheet when inflated. The inflatable portion may be removably attached to the sheet. The inflatable portion may also include a decorative surface layer disposed thereon for aesthetic purposes such as, but not limited to, representing a sports team, an event, a cause, or the like.

The valve may be an inflate valve, a multi-valve, a one-way valve, or any other type of valve suitable for the inflation and deflation of the inflatable portion.

It is contemplated that the arrangement of the sheet and the inflatable portion may include a variety of different combinations and the examples listed herein shall not be considered limiting. As a non-limiting example, the sheet may be generally square in shape and the inflatable portion may be disposed around the perimeter of the sheet such that when inflated, tension is applied to the sheet such that the sheet is pulled taut and may be rigid enough to write on. As a non-limiting example, the sheet may be generally circular in shape and the inflatable portion may be disposed around the perimeter of the sheet similar to that which was previously described. The inflatable portion may be deflated and the inflatable white board may be constructed and arranged to be foldable or may be rolled up for ease of storage or transport.

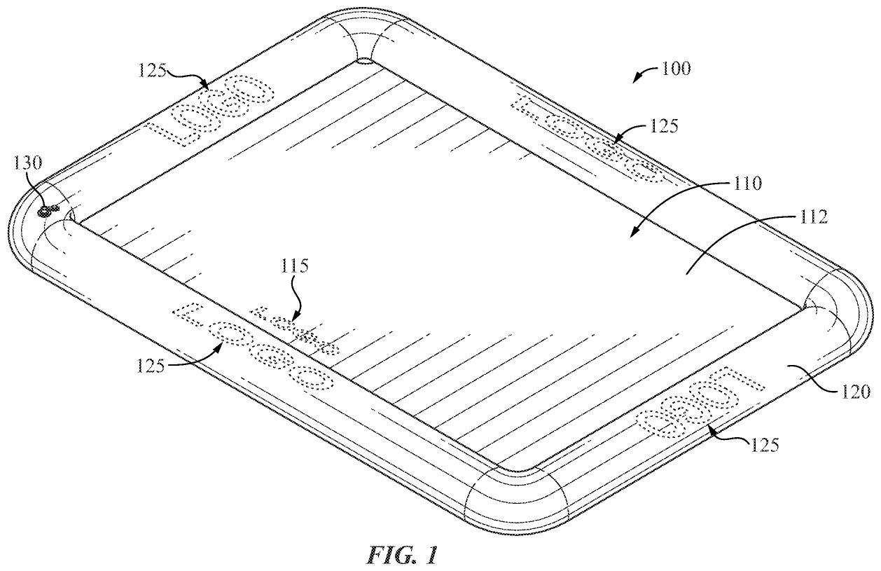

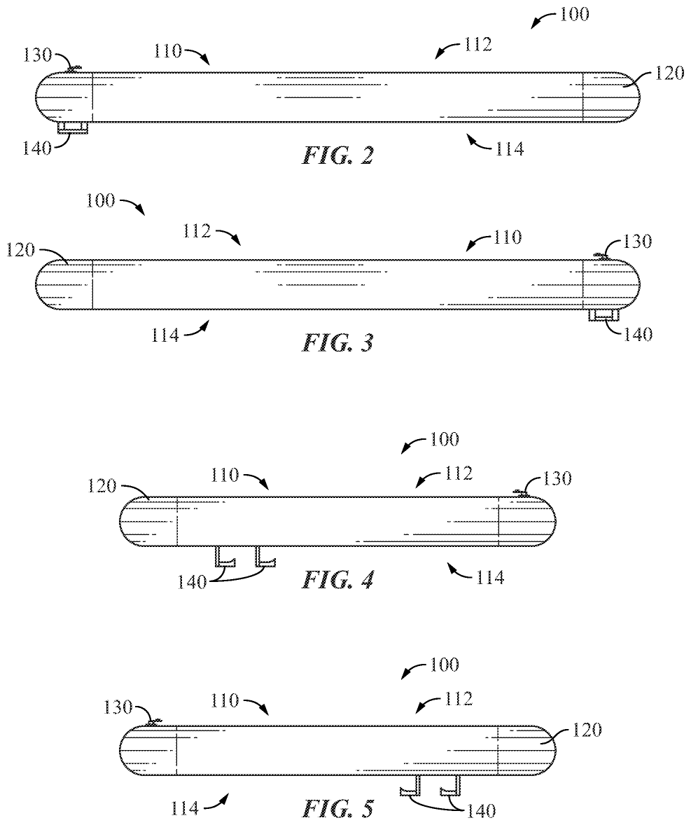

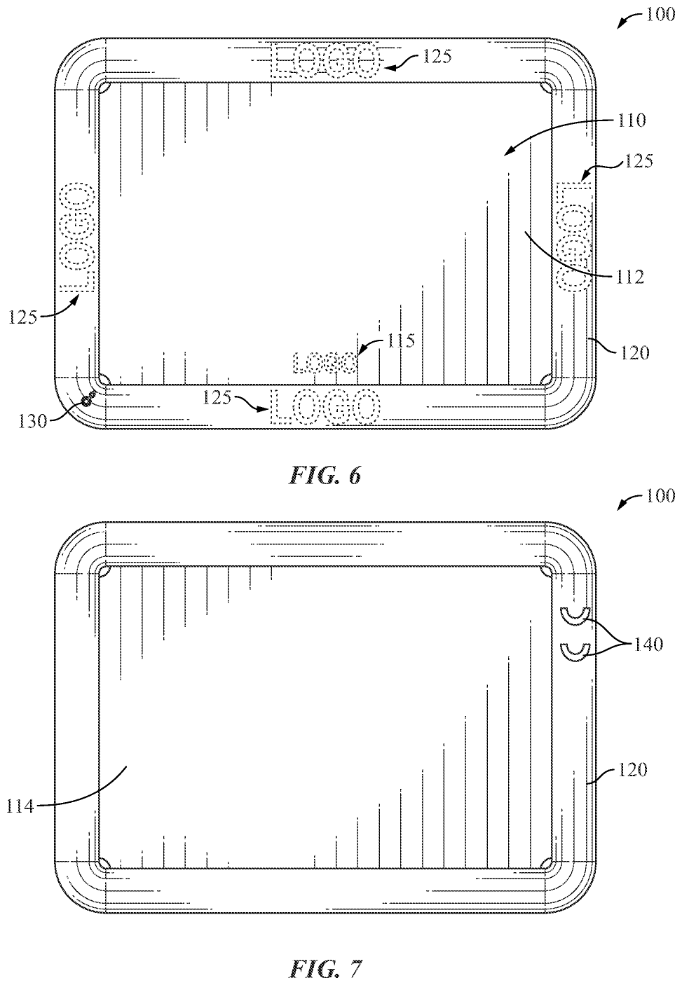

Referring to FIGS. 1-7, an inflatable whiteboard 100 includes a sheet 110 having a top layer 112 and/or a bottom layer 114. The inflatable whiteboard 100 and its parts may incorporate one or more of the characteristics and features described above for inflatable whiteboards. The sheet 110 may be removably attached to an inflatable portion 120 at least partially surrounding the sheet 110 or alternatively, framing the sheet 110 on the sheet's perimeter. The inflatable portion 120 may include a blowhole or valve 130 constructed and arranged to allow a user to inflate the inflatable portion 120. The inflatable whiteboard 100 also includes a writing instrument holder 140.

The sheet 110, the top layer 112 and/or the bottom layer 114 are made of a rigid and/or flexible material suitable for use with temporary markers, pens, pencils, or the like which may be easily erased from the top layer 112 and/or the bottom layer 114. As non-limiting examples, the sheet 110, the top layer 112, and/or the bottom layer 114 may be made of a rigid material such as plastic, paperboard, wood, metal, and/or other material. According to one or more aspects, the sheet 110, the top layer 112, and/or the bottom layer 114 may be a layer of rigid and/or flexible material suitable for use with permanent and/or temporary markers, pens, pencils, or the like which may (or may not) be easily erased from the sheet. According to one or more aspects, a writable surface layer (which may be the top layer 112 and/or the bottom layer 114) is disposed on the sheet 110 and is constructed and arranged for use with temporary markers, pens, pencils, or the like which may be easily erased from the surface layer. The surface layer may include materials suitable for the purposes of acting as a dry erase board including, but not limited to, melamine, hard coat laminates, painted metals, enamels, polypropylene films, tempered glass, or the like. According to one or more aspects, a surface layer may be disposed on the sheet 110 and which may be constructed and arranged for use with temporary markers, pens, pencils, or the like which may be easily erased from the surface layer. The surface layer has a writable surface logo area 115. A logo printed on the writable surface logo area 115 is not erasable. The benefit of a non-erasable logo is that it allows for marketing messages to be added to the inflatable whiteboard 100. According to one or more aspects, the writable surface logo area 115 is or has a removable and/or a non-removable sticker. According to one or more aspects, the writable surface logo area 115 is or has an erasable and/or a non-erasable writable area and/or writable sticker. According to one or more aspects, the sheet 110 has a plurality of writable surface logo areas 115 on the top layer 112 and/or the bottom layer 114.

The inflatable portion 120 is removably connected to the sheet 110 and constructed and arranged to provide rigidity to the sheet 110. According to one or more aspects, the inflatable portion 120 is removably connected to the sheet 110. The inflatable portion defines a hollow section therein which may be inflated through the blowhole 130. According to one or more aspects, the inflatable portion 120 incorporates the characteristics of the sheet 110 and has or partially has a surface which is writable and erasable.

The blowhole 130 may be an inflate blowhole, a multi-blowhole, a one-way blowhole, or any other type of blowhole or valve suitable for the inflation and deflation of the inflatable portion 120. The blowhole 130 is constructed and arranged to allow a user to inflate the inflatable portion 120 with air or any other suitable fluid. According to one or more aspects, the blowhole 130 is adapted to be used by a person, with the mouth, blowing air into the inflatable portion through the blowhole 130 and/or is adapted to receive a pump nozzle of a pump for inflating the inflatable portion. According to one or more aspects, the inflatable whiteboard 110 has one or a plurality of inflatable portions 120, each with its own blowhole or valve 130. The inflatable portion 120 may include a plurality of inflatable portions each having their own respective blowhole 130. The blowhole 130 is located at the inflatable portion 120. In configurations with multiple separate inflatable portions 120, the blowholes 130 are located at each of the multiple separate inflatable portions 120. The blowhole 130 is located towards the front of the inflatable whiteboard 100, facing the same direction as the top layer 112 (or front layer 112). According to one or more aspects, the one or more blowholes 130 (according to the configuration of the inflatable portion 120 or according to the number of inflatable portions 120 and their configuration, if more that one) are located on the inflatable portion(s) 120 facing towards the top (or front), the bottom (or back), the left, the right, down, up (or, the left, the right, down, up being the sides of the inflatable portion 120/inflatable whiteboard 100), the diagonal corners of the inflatable portion(s) 120, and/or at any angle between any of the aforementioned directions.

The inflatable portion 120 is constructed and arranged to form a frame around the sheet when inflated, as shown in FIGS. 1-7. The inflatable portion 120 is removably attached to the sheet 110. The inflatable portion 120 is attached to the sheet 110 with through-hole buttons, temporary glue, snap-on buttons, hooks, hook-and-loop fasteners (such as Velcro®), strings, tied knots, laces, and/or the like. According to one or more aspects, the inflatable portion 120 is permanently attached to the inflatable portion 120. The inflatable portion 120 may also include a decorative surface layer (or surface logo areas 125) disposed thereon for aesthetic purposes such as, but not limited to, representing a sports team, an event, a cause, or the like. The inflatable portion 120 has one or more inflatable portion surface logo areas 125. A logo printed on the one or more inflatable portion surface logo areas 125 is not erasable. According to one or more aspects, the one or more inflatable portion surface logo areas 125 is or has a removable and/or a non-removable sticker. According to one or more aspects, each of the one or more inflatable portion surface logo areas 125 is and/or has an erasable and/or a non-erasable writable area and/or writable sticker.

The writable surface logo area 115 and the one or more inflatable portion surface logo areas 125 have the same or different logos. According to one or more aspects, the one or more inflatable portion surface logo areas 125 have the same or different logos. As used herein and in the claims, the word “logo” refers to its general meaning and to any expression, content, words, symbols, drawings, figures, characters, and/or the like, used for decoration, marketing, advertising, messaging, raising awareness on a topic or issue, and/or the like.

The writing instrument holder 140 is attached to the inflatable portion 120. According to one or more aspects, writing instrument holder 140 is attached to the top layer 112 or the bottom layer 114. According to one or more aspects, one or more writing instrument holders 140 are attached to the sheet 110 (or to the top layer 112 and/or the bottom layer 114) and/or to the inflatable portion 120. The writing instrument holder 140 is configured and dimensioned and hold one or more permanent and/or temporary markers, pens, pencils, and/or the like. The writing instrument holder 140 comprises one or more loops, each having an opening through which a writing instrument (such as permanent and/or temporary markers, pens, pencils, and/or the like) can be inserted. The opening is dimensioned to receive the writing instrument and to cause pressure and friction between the writing instrument and both the writing instrument holder 140 and the inflatable portion area touching the writing instrument. With two or more loops, the writing instrument holder 140 can better hold the writing instrument and avoid the rotation and loosening of the writing instrument that is more likely to occur with only one loop. The distance between the loops is dimensioned, and the position and orientation relation between the loops is configured, such that all loops intended to operate to hold the writing instrument can effectively cause the friction to hold the instrument. For example, the distance between the loops cannot be greater than the length of a writing instrument, and the opening size cannot be so large that the writing instrument falls through and cannot be so small that the writing instrument does not fit through. The opening(s) of the loop(s) may be defined by the loop and/or between the inflatable portion 120/sheet 110 and the loop. The writing instrument holder 140 is attached to an area of the inflatable portion facing the same direction as the bottom layer 114. According to one or more aspects, the one or more writing instrument holders 140 are located/attached towards the front, back, and/or sides (up, down, left, and/or right) of the inflatable whiteboard 100, the sheet 110 (or the top layer 112 and/or the bottom layer 114) and/or the inflatable portion 120, and/or towards any location at any position between the foregoing areas or locations. According to one or more aspects, the writing instrument holder 140 comprises one or more loops, strings attached or tied or connected to a writing instrument, and/or one or more strings with distal ends attached or tied or connected to the sheet 110 and/or the inflatable portion 120, and to the writing instrument or to a cap/cover of the writing instrument (such that when snapping the writing instrument into the cap, the cap hangs from the string and holds the writing instrument).

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to one or more aspects, an inflatable whiteboard includes a sheet and an inflatable portion including a valve wherein the inflatable portion is constructed and arranged to provide rigidity to the inflatable whiteboard when the inflatable portion is inflated.

According to one or more aspects, an inflatable whiteboard includes a sheet including a top layer; an inflatable portion including a valve, the inflatable portion framing the perimeter of the sheet; and wherein the inflatable portion is constructed and arranged to provide rigidity to the inflatable whiteboard when the inflatable portion is inflated.

Many different embodiments have been disclosed herein, in connection with the above description and the drawing. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. An inflatable whiteboard comprising:
a sheet;
an inflatable portion comprising a valve wherein the inflatable portion is constructed and arranged to provide rigidity to the sheet when the inflatable portion is inflated.

2. The inflatable whiteboard of claim 1,
wherein the sheet has at least one logo area.

3. The inflatable whiteboard of claim 1,
wherein the inflatable portion has at least one logo area.

4. The inflatable whiteboard of claim 1 further comprising:
a writing instrument holder attached to the inflatable portion.

5. The inflatable whiteboard of claim 1,
wherein the sheet comprises a top layer and a bottom layer; and
wherein the top layer is writable and erasable.

6. The inflatable whiteboard of claim 5 further comprising:
a writing instrument holder attached to the inflatable portion.

7. The inflatable whiteboard of claim 6,
wherein the writing instrument holder is attached to an area of the inflatable portion facing the same direction as the bottom layer.

8. An inflatable whiteboard comprising:
a sheet comprising a top layer; and
an inflatable portion comprising a valve, the inflatable portion framing the perimeter of the sheet;
wherein the inflatable portion is constructed and arranged to provide rigidity to the inflatable whiteboard when the inflatable portion is inflated.

9. The inflatable whiteboard of claim 8,
wherein the sheet has at least one logo area.

10. The inflatable whiteboard of claim 8,
wherein the inflatable portion has at least one logo area.

11. The inflatable whiteboard of claim 8 further comprising:
a writing instrument holder attached to the inflatable portion.

12. The inflatable whiteboard of claim 8,
wherein the sheet comprises a top layer and a bottom layer; and
wherein the top layer is writable and erasable.

13. The inflatable whiteboard of claim 12 further comprising:
a writing instrument holder attached to the inflatable portion.

14. The inflatable whiteboard of claim 13,
wherein the writing instrument holder comprises one or more loops attached to the inflatable portion.

15. An inflatable whiteboard comprising:
a sheet comprising a top layer; and
an inflatable portion comprising a valve, the inflatable portion framing the perimeter of the sheet;
wherein the top layer can be written on with a writing instrument and erased.

16. The inflatable whiteboard of claim 15 further comprising:
a writing instrument holder attached to the inflatable portion.

17. The inflatable whiteboard of claim 16,
wherein the writing instrument holder comprises a string with a first distal end attached or tied to the inflatable portion and a second distal end attached or tied to a writing instrument or to a cap of a writing instrument.

18. The inflatable whiteboard of claim 16,
wherein the writing instrument holder comprises one or more loops attached to the inflatable portion.

19. The inflatable whiteboard of claim 18,
wherein the sheet further comprises a bottom layer; and
wherein the bottom layer can be written on with a writing instrument and erased.

20. The inflatable whiteboard of claim 19,
wherein the inflatable portion is constructed and arranged to provide rigidity to the inflatable whiteboard when the inflatable portion is inflated
